(19) United States
(12) Patent Application Publication
(10) Pub. No.: US 2013/0057803 A1
(43) Pub. Date: Mar. 7, 2013

(54) LIQUID CRYSTAL DISPLAY DEVICE AND PLANAR LIGHT SOURCE DEVICE PROVIDED TO LIQUID CRYSTAL DISPLAY DEVICE

(71) Applicant: Shigenori Tanaka, Osaka-shi (JP)

(72) Inventor: Shigenori Tanaka, Osaka-shi (JP)

(73) Assignee: SHARP KABUSHIKI KAISHA, Osaka (JP)

(21) Appl. No.: 13/697,612

(22) PCT Filed: Apr. 25, 2011
(86) PCT No.: PCT/JP2011/060088

§ 371 Date: Nov. 13, 2012

(30) Foreign Application Priority Data
Jun. 1, 2010 (JP) 2010-126168

(51) Int. Cl. G02F 1/13357; F21V 8/00

(52) U.S. Cl. 349/58; 362/611

(57) ABSTRACT

A liquid crystal module includes a planar light source device and a liquid crystal panel which are combined together by use of a double-sided adhesive tape (not illustrated). The double-sided adhesive tape is provided on a part of a resin frame, which part is on a light-exit-plane side. A part of the resin frame, which part is not provided with the double-sided adhesive tape, has an uneven surface or has a slit on a surface thereof. In other words, a part of the resin frame, which part corresponds to sections where the planar light source device and the liquid crystal panel are not combined together, has an uneven surface or has a slit on a surface thereof.

### TECHNICAL FIELD

The present invention relates to a liquid crystal display device and a planar light source device provided in the liquid crystal display device.

### BACKGROUND ART

Mobile information devices, such as laptop personal computers, PDAs (Personal Data Assistant), portable gaming devices, and mobile phones, are becoming prevalent in today's market place. Liquid crystal modules are widely used for displays of such mobile information devices. A liquid crystal module is basically made up of a backlight section and a liquid crystal display element section, and has (i) a planar light source device as the backlight section and (ii) a liquid crystal panel as the liquid crystal display element section. A conventional liquid crystal module is illustrated by FIG. 8. FIG. 8 is a view schematically illustrating a cross section of a conventional liquid crystal display device 30.

As illustrated in FIG. 8, the liquid crystal module 30 includes: a planar light source device 11 as a backlight section; and a liquid crystal panel 10 as a liquid crystal display element section. The planar light source device 11 includes (i) a reflective film 15, (ii) a resin frame 13 provided on the reflective film 15, (iii) a light guide plate 12 provided inside the resin frame 13, and (iv) an optical film 14 on the light guide plate 12. The liquid crystal panel 10 is made up of (a) a glass substrate 8 on which thin-film transistors (TFT), wires, or the like are provided, (b) a glass substrate 9 on which transparent electrodes, color filters, or the like are provided, (c) a liquid crystal material sealed in a gap between the glass substrate 8 and the glass substrate 9, and (d) polarizing plates 7 with which the glass substrate 8 and the glass substrate 9 are sandwiched. The liquid crystal module 30 is configured such that (A) when a light source (not illustrated) provided in the planar light source device 11 emits light, light emitted from the light source enters the light guide plate 12 and then (B) the light is efficiently guided through the light guide plate 12 toward a side closer to the liquid crystal panel 10 and converged by the optical film 14. This allows the planar light source device 11 to have even illuminance distribution, and therefore to illuminate the liquid crystal panel 10 by uniform light.

In such a liquid crystal module mounted on a mobile information device, the planar light source device 11 and the liquid crystal panel 10 are generally combined together by use of a double-sided adhesive tape 6. The double-sided adhesive tape 6 is provided between the planar light source device 11 and the liquid crystal panel 10, and specific examples of the provision are illustrated in FIGS. 9 and 10. FIGS. 9 and 10 each illustrate an example of how the double-sided adhesive tape 6 is provided.

As illustrated in FIG. 9, the double-sided adhesive tape 6 can be provided along four sides of a resin frame 13. In this case, the double-sided adhesive tape 6 is provided on a large area. In other words, the planar light source device 11 and the liquid crystal panel 10 are combined together via a large combining surface. This allows the planar light source device 11 and the liquid crystal panel 10 to be combined together with high strength.

In contrast, as illustrated in FIG. 10, it is also possible to provide the double-sided adhesive tape 6 along only two sides of the four sides of the resin frame 13. In this case, a less amount of the double-sided adhesive tape 6 is used compared with the case where the double-sided adhesive tape 6 is provided along the four sides of the resin frame 13, and it is therefore possible to reduce the production costs of the liquid crystal module 30.

It is thus preferable to provide the double-sided adhesive tape 6 along two sides of the resin frame 13, from the perspective of reduction in the cost of materials for the liquid crystal module 30. However, providing the double-sided adhesive tape 6 along two sides of the resin frame 13 poses a risk that foreign substances might enter a gap between the planar light source device 11 and the liquid crystal panel 10. A detailed explanation of this phenomenon will be provided below with reference to FIGS. 11 and 12. FIG. 11 is a view illustrating a cross section of the liquid crystal module 30 in a case where the double-sided adhesive tape 6 is provided along the four sides of the resin frame 13. FIG. 12 is a view illustrating a cross section of the liquid crystal module 30 in a case where the double-sided adhesive tape 6 is provided along two sides of the resin frame 13.

In the case where the double-sided tape 6 is provided along four sides of the resin frame 13 as illustrated in FIG. 11, a gap (clearance 19) between the planar light source device 11 and the liquid crystal panel 10 is sealed with the double-sided adhesive tape 6. On the other hand, in the case where the double-sided tape 6 is provided along two sides of the resin frame 13 as illustrated in FIG. 12, the planar light source device 11 and the liquid crystal panel 10 are not combined together at sections where the double-sided adhesive tape 6 is not provided. This creates the gap between the planar light source device 11 and the liquid crystal panel 10. Therefore, there is a possibility that foreign substances, such as dust floating in the air, enter the gap while the liquid crystal module 30 is in the process of being produced or assembled, or is being transferred from place to place. If the foreign substances reach a display area of the liquid crystal module 30, then the foreign substances block pixels of the liquid crystal module 30 due to smallness of the pixels in measure. Consequently, an image displayed by the liquid crystal module 30 in such a state is displayed with the foreign substances as shadows.

In other words, foreign substances attached to the display area become shadows in an image displayed by the liquid crystal module 30, and therefore causes lowering of the display quality of the liquid crystal module 30. The sizes of foreign substances and attachment locations of foreign substances that affect a displayed image differ depending on the characteristics of the liquid crystal module 30. In any case, however, it is desirable to prevent foreign substances from entering the gap between the planar light source device 11 and the liquid crystal panel 10. Hence, in order to prevent foreign substances from entering the gap, there has conventionally been no option but to provide the double-sided adhesive tape 6 along the four sides of the resin frame 13 despite high cost of materials for the liquid crystal module 30.

In order to deal with this problem, Patent Literature 1 discloses a liquid crystal display device in which a planar light source device is contained in an intermediate frame having spacers for preventing foreign substances from entering a gap between a liquid crystal panel and the planar light source device. Specifically, the liquid crystal display device is configured such that the intermediate frame contains the planar light source device therein while covering all the sides of the planar light source device in a direction from the liquid crystal panel with spacers integrally formed with the intermediate frame. The planar light source device is contained in the intermediate frame from a bottom thereof so that all the sides of the planar light source device are covered with the spacers. This prevents, without allowing for light leakage in the vicinity of the liquid crystal panel, foreign substances from entering a gap between the planar light source device and the liquid crystal panel.

CITATION LIST

### Patent Literatures

Patent Literature 1

Japanese Patent Application Publication, Tokukai, No. 2002-182184 A (Publication Date: June 26, 2002)

### SUMMARY OF INVENTION

### Technical Problem

With the technique disclosed in Patent Literature 1, it is not possible to sufficiently prevent foreign substances from entering a gap between a planar light source device and a liquid crystal panel. This is because the liquid crystal display device disclosed in Patent Literature 1 is configured such that the intermediate frame (in which the planar light source device is contained) and the liquid crystal panel are sandwiched between and fixed by two separate frames. According to the configuration, the intermediate frame and the liquid crystal panel are not combined together so that foreign substances can possibly enter from a gap between the intermediate frame and the liquid crystal panel.

Furthermore, the spacers of the intermediate frame are designed to cover all the sides of the planar light source device and so extend in a plane direction of the planar light source device. In other words, the spacers are not shaped so as to block foreign substances having entered the gap between the planar light source device and the liquid crystal panel. This poses a risk of allowing the foreign substances to reach the display area of the device. There thus remains a problem that foreign substances enter the gap between the planar light source device and the liquid crystal panel.

The present invention has been made in view of the foregoing problems, and it is an object of the present invention to provide: a liquid crystal display device capable of (i) reducing the amount of foreign substances entering a display area provided between a planar light source device and a liquid crystal panel and (ii) reducing production costs of a liquid crystal module; and a planar light source to be provided in the liquid crystal display device.

### Solution to Problem

In order to attain the object, a liquid crystal display device in accordance with the present invention includes: a planar light source device including a light source for emitting light toward outside of the planar light source device, a light guide plate for guiding the light therethrough and emitting out the light from a light exit plane thereof, and a frame for storing therein the light source and the light guide plate; and a liquid crystal panel provided on a light-exit-plane side of the frame, at least a part of the frame on the light-exit-plane side and the liquid crystal panel facing each other with a gap in between, and the part having an uneven surface or a slit on a surface thereof.

According to the configuration of the planar light source device, a part of the frame, which part is combined with the liquid crystal panel with a gap in between, has an uneven surface or has a slit on a surface. In other words, a part of the frame has an uneven surface or has a slit on a surface thereof, which part corresponds to sections where the planar light source device and the liquid crystal panel are not in contact with each other. This causes foreign substances having entered the liquid crystal display device to be easily collected on the uneven surface or the slit. Therefore, even in a case where foreign substances enter the liquid crystal display device, it is possible to reduce the amount of foreign substances entering a gap between the planar light source device and the liquid crystal panel. Consequently, the foreign substances are prevented from entering a display area, and it is therefore possible to maintain a high display quality of the liquid crystal display device.

With such a configuration of a liquid crystal display device, it is possible, even in a case where there is a gap between a planar light source device and a liquid crystal panel, to reduce the amount of foreign substances entering the display area through the gap. Thus, it is possible to obtain a liquid crystal display device delivering high display quality even if a double-sided adhesive tape is not provided along four sides of the frame as in the case of a conventional liquid crystal display device. This reduces the amount of a double-sided adhesive tape to be used, and therefore allows for reduction in the production costs of a liquid crystal display device.

In order to attain the object, a planar light source device in accordance with the present invention is provided in a liquid crystal display device including a liquid crystal panel and is provided so as to face the liquid crystal panel, the planar light source device including a light source for emitting light toward outside of the planar light source device, a light guide plate for guiding the light therethrough and emitting out the light from a light exit plane thereof, and a frame for storing therein the light source and the light guide plate, at least a part of the frame on a light-exit-plane side and the liquid crystal panel facing each other with a gap in between, and the part having an uneven surface or a slit on a surface thereof.

According to the configuration, foreign substances having entered the planar light source device are likely to be collected on the uneven surface of or the slit of the frame. This allows for reduction in the amount of foreign substances entering a display area.

Additional objects, features, and strengths of the present invention will be made clear by the description below.

Furthermore, the advantages of the present invention will be evident from the following explanation with reference to the drawings.

### Advantageous Effects of Invention

According to a liquid crystal display device in accordance with the present invention, foreign substances having entered the liquid crystal display device are likely to be collected on an uneven surface of or a slit of a frame provided in a planar light source device. This causes, even in a case where foreign substances enter the liquid crystal display device, the foreign substances to be less likely to enter a gap between the planar light source device and a liquid crystal panel. Consequently, the foreign substances are prevented from entering a display area, and it is therefore possible to maintain a high display quality of the liquid crystal display device.

With such a configuration, it is also possible to reduce the amount of a double-sided adhesive tape to be provided in the device. This allows for reduction in the production costs of the liquid crystal display device.

### BRIEF DESCRIPTION OF DRAWINGS

FIG. 1

FIG. 1 is a cross-sectional view illustrating a configuration of a liquid crystal module including a planar light source device in accordance with an embodiment of the present invention.

FIG. 2

(a) of FIG. 2 is a view of a planar light source device in accordance with an embodiment of the present invention, observed from a light-exit-plane side. (b) of FIG. 2 is a view illustrating a cross section of the planar light source device in accordance with the embodiment of the present invention.

FIG. 3

FIG. 3 is a view illustrating a cross section of a liquid crystal display module including a planar light source device in accordance with an embodiment of the present invention.

FIG. 4

FIG. 4 is a view illustrating a cross section of a liquid crystal display module including a planar light source device in accordance with an embodiment of the present invention.

FIG. 5

FIG. 5 is a view illustrating a cross section of a liquid crystal display module including a planar light source device in accordance with an embodiment of the present invention.

FIG. 6

(a) of FIG. 6 is a view of a planar light source device in accordance with an embodiment of the present invention, observed from a light-exit-plane side. (b) of FIG. 6 is an enlarged view illustrating a resin frame in accordance with the embodiment of the present invention.

FIG. 7

(a) of FIG. 7 is a view illustrating an example shape of a slit provided on a resin frame in accordance with an embodiment of the present invention. (b) of FIG. 7 is a view illustrating an example shape of a slit provided on a resin frame in accordance with an embodiment of the present invention.

FIG. 8

FIG. 8 is a view schematically illustrating a cross section of a conventional liquid crystal module.

FIG. 9

FIG. 9 is a view illustrating an example of how a double-sided adhesive tape is provided.

FIG. 10

FIG. 10 is a view illustrating an example of how a double-sided adhesive tape is provided.

FIG. 11

FIG. 11 is a view illustrating a cross section of a conventional liquid crystal module.

FIG. 12

FIG. 12 is a view illustrating a cross section of a conventional liquid crystal module.

### DESCRIPTION OF EMBODIMENTS

### Summary of Planar Light Source Device 1

A liquid crystal module (liquid crystal display device) is basically made up of a backlight section and a liquid crystal display element section and has a planar light source device as the backlight section and a liquid crystal panel as the liquid crystal display element section. A planar light source device in accordance with the present embodiment will be schematically described with reference to FIG. 2. (a) of FIG. 2 is a view of a planar light source device 1 observed from a light-exit-plane side. (b) of FIG. 2 is a view of the planar light source device 1 taken along the line A-A′ of (a) of FIG. 2.

As illustrated in (b) of FIG. 2, the planar light source device 1 includes a light guide plate 2, a resin frame 3, an optical film 4, a reflective film 5, and a light source (not illustrated). The light guide plate 2 is provided inside the resin frame 3 provided on the reflective film 5, and the optical film 4 is further provided on the light guide plate 2. The light source is provided on a side of the light guide plate 2, and is connected onto a flexible substrate 16. The planar light source device 1 is configured such that (i) light having been emitted from the light source enters the light guide plate 2, (ii) the light is subjected to multi-reflection in the light guide plate 2, and is then emitted out from a surface (light exit plane) of the light guide plate 2 which surface is closer to a liquid crystal panel (not illustrated), and then (iii) the light is converged by the optical film 4 so as to illuminate the liquid crystal panel. The light emitted from the light source is thus guided with efficiency through the light guide plate 2 toward the side closer to the liquid crystal panel, and is then converged by the optical film 4. This allows the planar light source device 1 to have even illuminance distribution, and therefore to illuminate the liquid crystal panel by uniform light. The reflective film 5 is for reflecting, back into the light guide plate 2, light which has escaped from the light guide plate 2 to a side closer to the reflective film 5.

The planar light source device 1 constitutes, together with the liquid crystal panel, the liquid crystal module. The planar light source device 1 and the liquid crystal panel are combined together with the use of an adhesive such as a double-sided adhesive tape 6 as typically. For example, as illustrated in (a) of FIG. 2, the double-sided adhesive tape 6 is provided along two of four sides of the resin frame 3. In the present embodiment, a part of the resin frame 3 has an uneven surface, which part corresponds to sections where the double-sided adhesive tape 6 is not provided (i.e. sections where the planar light source device 1 and the liquid crystal panel face each other with a gap therebetween) (see (b) of FIG. 2). With the configuration of the liquid crystal module including the planar light source device 1, it is possible to reduce the amount of foreign substances entering the gap between the planar light source device 1 and the liquid crystal panel (the details will be described later).

(Configuration of Liquid Crystal Module 20)

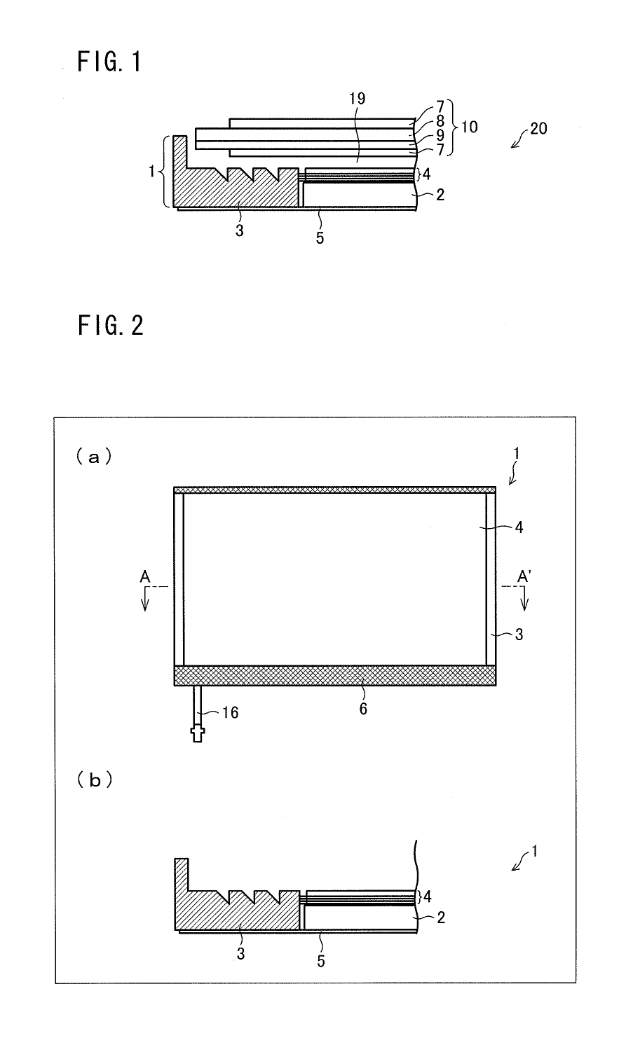

The following description will discuss a liquid crystal module 20 in detail with reference to FIG. 1. FIG. 1 is a cross-sectional view illustrating a configuration of the liquid crystal module 20 employing the planar light source device 1.

As described above, the liquid crystal module 20 is made up of a backlight section and a liquid crystal display element section. As illustrated in FIG. 1, (i) the liquid crystal module 20 includes the planar light source device 1 as the backlight section and a liquid crystal panel 10 as the liquid crystal display element section and (ii) the planar light source device 1 and the liquid crystal panel 10 are combined together via the double-sided adhesive tape 6. The double-sided adhesive tape 6 is provided on at least a part of an edge of the planar light source device 1. Examples of a material for the double-sided adhesive tape 6 are not limited to any specific ones, provided that the material has adhesion. For example, a well-known double-sided adhesive tape can be used as the double-sided adhesive tape 6. Alternatively, a light shielding tape provided with adhesive layers can be used as the double-sided adhesive tape 6 as well. The use of a light shielding tape makes it preventable that light, which is emitted from the light guide plate 2 so as to illuminate the liquid crystal panel 10, leaks into an area where illumination is unnecessary. Note that it is also possible to provide a light shielding tape apart from the double-sided adhesive tape 6.

The liquid crystal panel 10 includes (i) a glass substrate 8 on which thin-film transistors (TFT), wires, or the like are provided, (ii) a glass substrate 9 on which transparent electrodes, color filters, or the like are provided, (iii) a liquid crystal material sealed in a gap between the glass substrate 8 and the glass substrate 9, and (iv) polarizing plates 7 with which the glass substrate 8 and the glass substrate 9 are sandwiched. The planar light source device 1 includes the light guide plate 2, the resin frame 3, the optical film 4, the reflective film 5, and the light source (not illustrated) as described above. The light guide plate 2 is stored in the resin frame 3 provided on the reflective film 5, and the optical film 4 is provided on the light guide plate 2. The optical film 4 is supported by the resin frame 3. A part of the resin frame 3 has an uneven surface, which part corresponds to sections where the double-sided adhesive tape 6 is not provided.

In general, optical films include lens sheets, diffusing sheets etc. For example, there are double-prism optical films including (i) two diffusing sheets and (ii), between the diffusing sheets, two lens sheets whose prism patterns are perpendicular to each other. There are also inverse-prism optical films in which a single lens sheet has a prism pattern facing downwards. In the present embodiment, the optical film 4 can have any of such forms, and is not limited to a particular form.

Examples of a light source of a planar light source device encompass a light-emitting diode (LED), a laser diode

(LD), and a cold-cathode fluorescent lamp (CCFL). For the planar light source device 1, it is possible to employ (i) a direct system in which any one of the light sources is provided directly below the liquid crystal module 20 or (ii) an edge light system in which any one of the light sources is provided on a side of the light guide plate 2.

Note that, as described earlier, a part of the resin frame 3 has an uneven surface, which part corresponds to sections where the double-sided adhesive tape 6 is not provided. In other words, in the liquid crystal module 20, a part of the resin frame 3 which part corresponds to sections where the planar light source device 1 and the liquid crystal panel 10 are not in contact with each other has an uneven surface. If the liquid crystal module 20 has sections where the planar light source device 1 and the liquid crystal panel 10 are not in contact with each other, then foreign substances such as dust might enter the gap between the planar light source device 1 and the liquid crystal panel 10 while the liquid crystal module 20 is in the process of being produced or assembled, or is being transferred from place to place. If the foreign substances even reach inside a display area of the liquid crystal module 20, then the foreign substances may block pixels of the liquid crystal module 20 due to smallness of the pixels in measure. Consequently, an image displayed by the liquid crystal module 20 in such a state is displayed with the foreign substances as shadows, so that the display quality of the liquid crystal module 20 is lowered. However, the surface of the resin frame 3 in accordance with the present embodiment has uneven parts. Therefore, foreign substances having entered the liquid crystal module 20 are likely to be collected in the uneven parts. This allows for reduction in the amount of foreign substances entering the gap between the planar light source device 1 and the liquid crystal panel 10. Consequently, the foreign substances are prevented from entering inside the display area, and it is therefore possible to maintain a high display quality of the liquid crystal module 20.

Even in a case where the double-sided adhesive tape 6 is provided on two sides of the resin frame 3 (i.e. a part of a space between the planar light source device 1 and the liquid crystal panel 10 is not provided with the double-sided adhesive tape 6), the above configuration allows for reduction in the amount of foreign substances entering the liquid crystal module 20. Hence, even if the double-sided adhesive tape 6 is not provided along the four sides of the resin frame 3, it is still possible to obtain the liquid crystal module 20 with high display quality. This allows for reduction in the amount of the double-sided adhesive tape 6 to be used, and therefore allows for reduction in production costs of the liquid crystal module 20.

Note that the resin frame 3 is formed by use of a mold. Thus, preparation of an unevenly shaped mold in advance makes it easy to form a resin frame 3 having unevenly shaped surfaces. This makes it unnecessary, during the production of the planar light source device 1, to add a new step of forming uneven shapes on surfaces of the resin frame 3. This prevents a production process of the planar light source device 1 from being complicated. Since the resin frame 3 having uneven surfaces is formed by use of a mold (and it is not that uneven shapes are separately formed on the surfaces of the resin frame 3), the material cost for the planar light source device 1 can be kept low.

### Examples of Uneven Shape

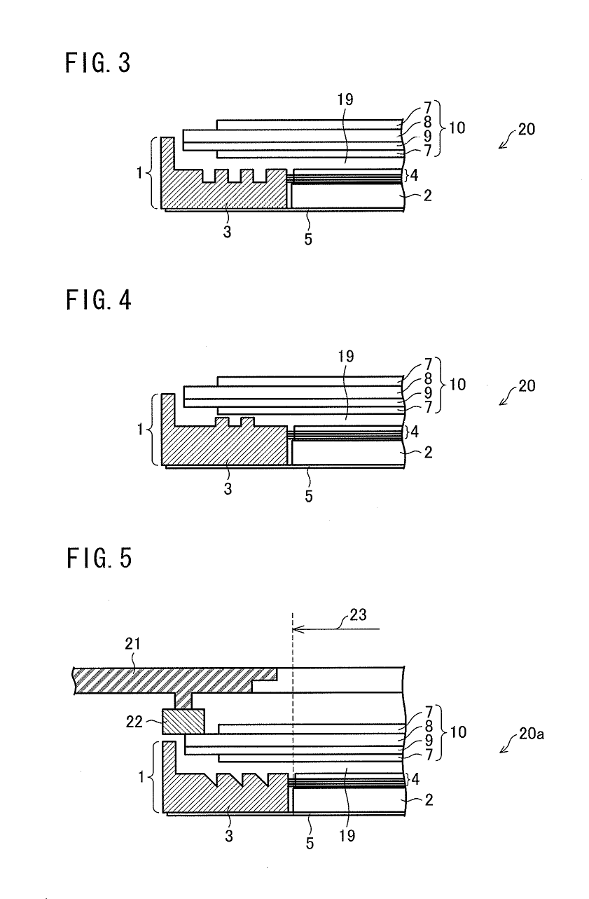

An uneven shape of each of the surfaces of the resin frame 3 is not limited to any particular one, provided that the uneven shape can prevent foreign substances from entering the liquid crystal module 20. For example, FIG. 1 illustrates the uneven shape of the surface of the resin frame 3 with grooves each having a substantially V-shaped cross section, but the uneven shape is not limited to this. Other examples of the uneven shape are illustrated in FIGS. 3 and 4. FIG. 3 is a view illustrating (i) an example of a cross section of the resin frame 3 as well as (ii) a cross section of the liquid crystal module 20 including the planar light source device 1. FIG. 4 is another view illustrating (i) an example of a cross section of the resin frame 3 as well as (ii) a cross section of the liquid crystal module 20 including the planar light source device 1.

The uneven shape can be made, for example, with grooves each having a quadrilateral cross section (see FIG. 3). It is thus preferable that (i) the uneven shape of the surface of the resin frame 3 has depressed parts (grooves) for collecting foreign substances which have entered the gap between the planar light source device 1 and the liquid crystal panel 10, and (ii) the uneven shape serves to prevent the foreign substances from entering inside the display area of the liquid crystal module 20.

Alternatively, as illustrated in FIG. 4, the uneven shape can be made by forming protruding parts on a surface of the resin frame 3. In a case where depressed parts such as ones illustrated in FIGS. 1 and 3 are provided, foreign substances having entered the gap between the planar light source device 1 and the liquid crystal panel 10 can easily be collected in the depressed parts. This allows for reduction in the amount of the foreign substances entering the display area. On the other hand, in a case where protruding parts such as ones illustrated in FIG. 4 are provided on a surface of the resin frame 3, foreign substances which are about to enter the gap between the planar light source device 1 and the liquid crystal panel 10 are blocked by the protruding parts of the resin frame 3 from entering the display area. It is thus effective to configure the uneven shape to block foreign substances from entering, in the first place, the gap between the planar light source device 1 and the liquid crystal panel 10. Note that, although the protruding parts illustrated in FIG. 4 each have a substantially quadrilateral cross section, the shapes of the protruding parts are not limited to this. For example, the cross section of each protruding part can have a different polygonal shape such as a triangular shape. As an alternative of protruding parts, a curved protruding part can be provided.

Note that, although, in (a) of FIG. 2, the double-sided adhesive tape 6 is provided along the two sides of the resin frame 3, examples of how to provide a double-sided adhesive tape 6 are not limited to this. In fact, it is also possible to provide the double-sided adhesive tape 6 along three sides of or one side of the resin frame 3. Provided that the planar light source device 1 and the liquid crystal panel 10 are combined together, there is thus no particular restriction as to (i) which sides of the resin frame 3 are to be provided with the double-sided adhesive tape 6 and (ii) how many sides of the resin frame 3 are to be provided with the double-sided adhesive tape 6. That is, the present embodiment can be implemented under a condition in which at least one side of the resin frame 3 is not provided with the double-sided adhesive tape 6.

For example, the planar light source device 1 and the liquid crystal panel 10 can be combined together without a double-sided adhesive tape 6. One example of such a case is illustrated in FIG. 5. FIG. 5 is a view illustrating a cross section of a liquid crystal module 20a including a planar light source device 1 to which the double-sided adhesive tape 6 is not provided.

In a case where the planar light source device 1 and the liquid crystal panel 10 are combined together without the double-sided adhesive tape 6, the planar light source device 1 and the liquid crystal panel 10 are sealed in a housing member 21 such as a bezel (see FIG. 5). By pressing a non-display area of the liquid crystal panel 10 against the planar light source device 1 with the use of the housing member 21, it is possible to combine the planar light source device 1 and the liquid crystal panel 10 together. In so doing, it is preferable that the liquid crystal panel 10 is pressed against the planar light source device 1 via a cushioning member 22 so that the housing member 21 does not cause damage to a surface of the liquid crystal panel 10. It is also preferable that at least a portion of the housing member 21 which portion corresponds to a display area 23 of the liquid crystal module 20a is made of a translucent material so that the housing member 21 does not block light which has been emitted from the planar light source device 1.

In the case where the housing member 21 is thus used, a clearance 19 made between the planar light source device 1 and the liquid crystal panel 10 is small. However, it is still possible that foreign substances such as dust enter the clearance 19. Therefore, also in a case where the double-sided adhesive tape 6 is not used, the entire surface of the resin frame 3 is configured to be uneven, thereby reducing the amount of foreign substances entering the clearance 19.

### Another Embodiment

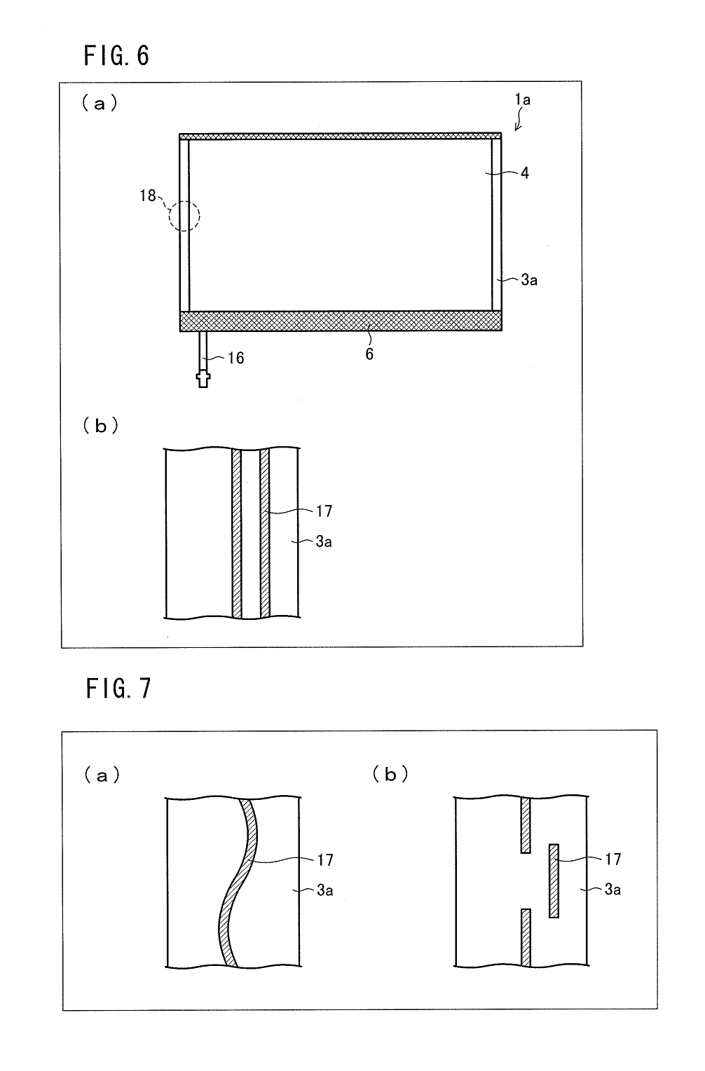

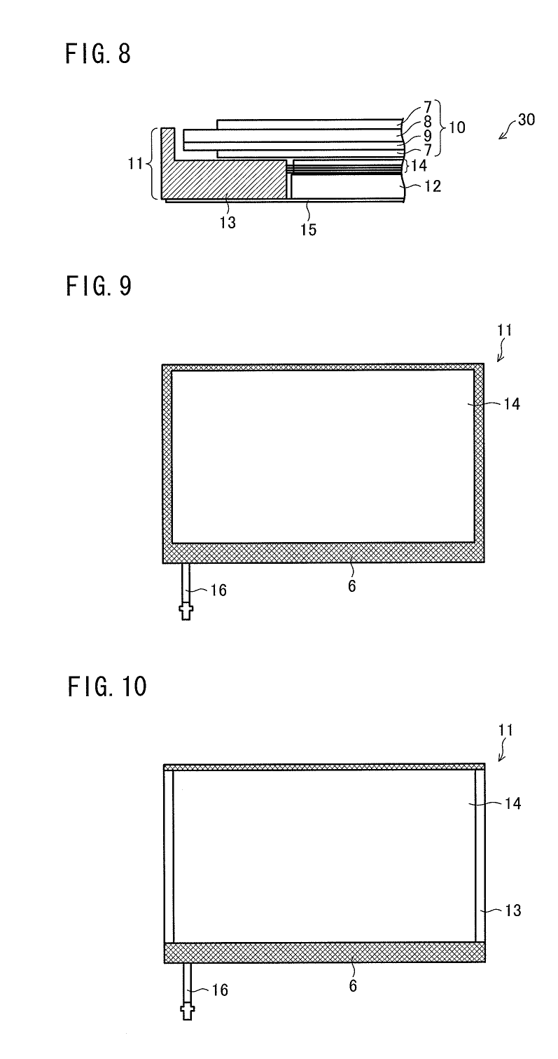

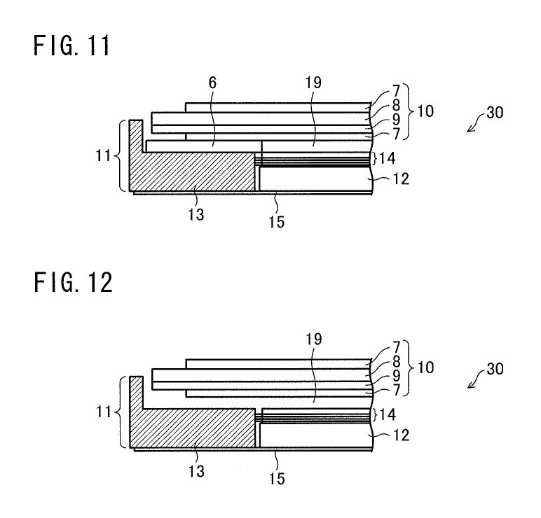

In the previous embodiments, the surface of the resin frame 3 of the planar light source device 1 is configured to be uneven. However, the present invention is not limited to such a configuration. For example, it is possible to provide slits in the resin frame 3. One example of such a configuration is illustrated in FIG. 6. (a) of FIG. 6 is a view of a planar light source device 1 a observed from a light-exit-plane side. (b) of FIG. 6 is an enlarged view of a part 18 illustrated in (a) of FIG.

6.

For example, assume that, as illustrated in (a) of FIG. 6, a double-sided adhesive tape 6 is provided along two sides of a resin frame 3a in order that the planar light source device 1a and a liquid crystal panel 10 are combined together. In this case, as illustrated in (b) of FIG. 6, slits 17 are provided on parts of the resin frame 3a which parts correspond to sections where the double-sided adhesive tape 6 is not provided. This makes it likely that foreign substances are collected in the slits 17, and therefore allows for reduction in the amount of foreign substances entering a gap between the planar light source device 1a and the liquid crystal panel 10. Since the foreign substances are consequently prevented from entering a display area, it is possible to maintain a high display quality of a liquid crystal module 20.

With the configuration, it is still possible to reduce the amount of foreign substances even if the double-sided adhesive tape 6 is not provided along all of the four sides of the resin frame 3a. This reduces the amount of the double-sided adhesive tape 6 to be used, and therefore allows for reduction in the production costs of the liquid crystal module 20.

Note that, in the case where the slits 17 are provided on the resin frame 3, the resin frame 3 is also formed by use of a mold. Thus, preparation of a mold in advance for forming the slits 17 makes it easy to form a resin frame 3 having slits 17. This makes it unnecessary, during the production of the planar light source device 1a, to add a new step of forming slits 17 on the resin frame 3. This prevents a production process of the planar light source device 1a from being complicated.

(b) of FIG. 6 illustrates the configuration in which the slits 17 provided on the resin frame 3 are configured to be straight. However, the shape of each slit 17 is not limited to any particular one, provided that the shape prevents foreign substances from entering the display area. Alternative shapes of slits 17 to be provided on the resin frame 3 are illustrated in FIG. 7.(a) of FIG. 7 is a view illustrating an example shape of a slit 17 provided on the resin frame 3, and is an enlarged view of the resin frame 3. (b) of FIG. 7 is another view illustrating an example shape of a slit 17 provided on the resin frame 3, and is another enlarged view of the resin frame 3.

As illustrated in (a) of FIG. 7, it is possible to form the slit 17 having a curved shape. Alternatively, as illustrated in (b) of FIG. 7, it is possible to form the slit 17 which is cut into pieces so as to look like a broken line. It is thus possible that (i) a plurality of slits 17 are provided on the resin frame 3 and (ii) the slit(s) 17 has/have a curved shape(s) or has/have breaks therein. In short, the slit(s) 17 provided on the resin frame 3 preferably has/have a shape(s) so as to collect foreign substances having entered the gap between the planar light source device 1a and the liquid crystal panel 10 so that the foreign substances are prevented from entering the display area of the liquid crystal module 20.

Note that, although (a) of FIG. 6 illustrates the configuration in which the double-sided adhesive tape 6 is provided along the two sides of the resin frame 3a, it is also possible to provide the double-sided adhesive tape 6 along three sides of or one side of the resin frame 3a. Provided that the planar light source device la and the liquid crystal panel 10 can be combined together, there is thus no particular restriction as to (i) which sides of the resin frame 3a are to be provided with the double-sided adhesive tape 6 and (ii) how many sides of the resin frame 3a are to be provided with the double-sided adhesive tape 6. That is, the present embodiment can be implemented under a condition in which at least one side of the resin frame 3a is not provided with the double-sided adhesive tape 6.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

### Summary of Embodiments

A liquid crystal display device in accordance with the present invention further includes a housing member for (i) holding, on the light-exit-plane side of the planar light source device, the liquid crystal panel and (ii) storing therein the planar light source device and the liquid crystal panel, an entire surface of the frame on the light-exit-plane side and the liquid crystal panel facing each other with a gap in between.

With the configuration, even in a case where (i) the planar light source device and the liquid crystal panel are combined together without the use of an adhesive substance such as a double-sided adhesive tape and (ii) foreign substances enter the liquid crystal display device, it is still possible to reduce the amount of foreign substances entering a gap between the planar light source device and the liquid crystal panel. Consequently, the foreign substances are prevented from entering a display area, and it is therefore possible to maintain a high display quality of the liquid crystal display device.

The liquid crystal display device in accordance with the present invention is configured such that the other part of the frame on the light-exit-plane side is combined with the liquid crystal panel by use of an adhesive substance.

With the configuration, even in a case where an adhesive substance is provided along two sides of the frame out of the total of four sides (i.e. in a case where a part of a gap between the planar light source device and the liquid crystal panel is not provided with the adhesive substance), it is still possible to reduce the amount of foreign substances entering the display area through the part. This realizes a liquid crystal display device having high display quality without providing the adhesive substance along the four sides of the frame. Therefore, the amount of an adhesive substance to be provided is reduced, and it is therefore possible to reduce the production costs of the liquid crystal display device.

The liquid crystal display device in accordance with the present invention is configured such that a cross section of the uneven surface has (i) depressed parts each of which is substantially V-shaped or (ii) protruding parts each of which has a substantially quadrilateral shape.

According to the configuration, foreign substances having entered the liquid crystal display device are likely to be collected on the depressed parts of the uneven surface of the frame. This prevents the foreign substances from entering the display area of the liquid crystal display device.

The liquid crystal display device in accordance with the present invention is configured such that the slit is configured to be straight or curved.

The liquid crystal display device in accordance with the present invention is configured such that the slit is cut into pieces so as to look like a broken line.

With each of the configuration, foreign substances having entered the liquid crystal display device are likely to be collected in the slit. This prevents the foreign substances from entering the display area of the liquid crystal display device.

The liquid crystal display device in accordance with the present invention is configured such that the adhesive substance is a double-sided adhesive tape.

With the configuration, even in a case where a double-sided adhesive tape is provided along two sides of the frame out of the total of four sides (i.e. in a case where a part of a gap between the planar light source device and the liquid crystal panel is not provided with the double-sided adhesive tape), it is still possible to reduce the amount of foreign substances entering the display area through the part. This realizes a liquid crystal display device having high display quality without providing the adhesive substance along the four sides of the frame. Therefore, the amount of a double-sided adhesive tape to be provided is reduced, and it is therefore possible to reduce the production costs of the liquid crystal display device.

The embodiments, which have been discussed in the detailed description, are illustrative only, which should not be narrowly interpreted within the limits of such embodiments, but are rather meant to be applied in any variations within the spirit of the present invention, provided that such variations do not exceed the scope of the patent claims set forth below.

### INDUSTRIAL APPLICABILITY

A liquid crystal display device in accordance with the present invention is applicable to a display of a mobile information device including a laptop computer, a mobile information terminal, a mobile gaming device, a mobile phone, or the like.

### REFERENCE SIGNS LIST

1, 1a, 11 Planar light source device
2, 12 Light guide plate
3, 3a, 13 Resin frame
4, 14 Optical film
5, 15 Reflective film
6 Double-sided adhesive tape
7 Polarizing plate
8, 9 Glass substrate
10 Liquid crystal panel
16 Flexible substrate
17 Slit
18 Part
19 Clearance
20, 20a, 30 Liquid crystal module
21 Housing member
22 Cushioning member
23 Display area

1. A liquid crystal display device comprising:
a planar light source device including
a light source for emitting light toward outside of the planar light source device,
a light guide plate for guiding the light therethrough and emitting out the light from a light exit plane thereof, and
a frame for storing therein the light source and the light guide plate; and
a liquid crystal panel provided on a light-exit-plane side of the frame,
at least a part of the frame on the light-exit-plane side and the liquid crystal panel facing each other with a gap in between, and
the part having an uneven surface or a slit on a surface thereof.

2. A liquid crystal display device as set forth in claim 1, further comprising a housing member for (i) holding, on the light-exit-plane side of the planar light source device, the liquid crystal panel and (ii) storing therein the planar light source device and the liquid crystal panel,
an entire surface of the frame on the light-exit-plane side and the liquid crystal panel facing each other with a gap in between.

3. The liquid crystal display device as set forth in claim 1, wherein the other part of the frame on the light-exit-plane side is combined with the liquid crystal panel by use of an adhesive substance.

4. The liquid crystal display device as set forth in claim 1, wherein a cross section of the uneven surface has (i) depressed parts each of which is substantially V-shaped or (ii) protruding parts each of which has a substantially quadrilateral shape.

5. The liquid crystal display device as set forth in claim 1, wherein the slit is configured to be straight or curved.

6. The liquid crystal display device as set forth in claim 5, wherein the slit is cut into pieces so as to look like a broken line.

7. The liquid crystal display device as set forth in claim 3, wherein the adhesive substance is a double-sided adhesive tape.

8. A planar light source device which is provided in a liquid crystal display device including a liquid crystal panel and is provided so as to face the liquid crystal panel,
the planar light source device including
a light source for emitting light toward outside of the planar light source device,
a light guide plate for guiding the light therethrough and emitting out the light from a light exit plane thereof, and
a frame for storing therein the light source and the light guide plate,
at least a part of the frame on a light-exit-plane side and the liquid crystal panel facing each other with a gap in between, and the part having an uneven surface or a slit on a surface thereof.
